(19) United States
(12) Patent Application Publication
(10) Pub. No.: US 2026/0281496 A1
(43) Pub. Date: Sep. 17, 2026

(54) VIDEO DATA TRANSMISSION METHOD AND DEVICE, STORAGE MEDIUM, AND SYSTEM

(71) Applicant: CLOUD INTELLIGENCE ASSETS HOLDING (SINGAPORE) PRIVATE LIMITED, Singapore (SG)

(72) Inventors: Jinjie XU, Hangzhou (CN); Wei TIAN, Shanghai (CN); Deng ZHAO, ShenZhen (CN)

(21) Appl. No.: 19/165,096

(22) PCT Filed: Jan. 11, 2024
(86) PCT No.: PCT/CN2024/071804

§ 371 Date: Sep. 12, 2025

(30) Foreign Application Priority Data
Mar. 13, 2023 (CN) 202310267209.3

(51) Int. Cl. H04N 21/437; G06F 3/14; H04N 19/142; H04N 19/172; H04N 19/177; H04N 19/423; H04N 19/70; H04N 21/433; H04N 21/6405; H04N 21/858

(52) U.S. Cl. CPC H04N 21/437; G06F 3/1454; H04N 19/142; H04N 19/172; H04N 19/177; H04N 19/423; H04N 19/70; H04N 21/4331; H04N 21/6405; H04N 21/8586

(57) ABSTRACT

A video data transmission method and device, a storage medium, and a system are provided. The method comprises: in response to establishing a communication connection with a server end, a client sends to the server end an obtaining request for obtaining a key frame, to enable the server end to encodes a current to-be-transmitted video image into a first key frame; the client receives the first key frame fed back by the server, and decodes the first key frame according to first decoding information included in the first key frame to display a decoded video image.

This disclosure claims priority to Chinese Patent Application No. 202310267209.3, filed with the China National Intellectual Property Administration on Mar. 13, 2023 and entitled “VIDEO DATA TRANSMISSION METHOD AND DEVICE, STORAGE MEDIUM, AND SYSTEM”, which is incorporated herein by reference in its entirety.

### TECHNICAL FIELD

This disclosure relates to the field of Internet technologies, and in particular, to a video data transmission method, a device, a storage medium, and a system.

### BACKGROUND

Using a video live streaming application as an example, an encoder in a server end encodes, based on a set length of a group of pictures (Group Of Pictures, GOP for short), several video images included in a live streaming video, to sequentially generate segments of the GOP, and a decoder in a client decodes each received video image frame, to render and display the decoded video images. The GOP includes a group of consecutive pictures, including an I-frame and a plurality of B-frames and P-frames that are after the I-frame. The I-frame is an intra-encoded frame (also referred to as a key frame), the P-frame is a forward predicted frame (also referred to as a forward reference frame), and the B-frame is a bidirectional interpolated frame (also referred to as a bidirectional reference frame). Actually, a length of one GOP is a distance between two I-frames. For example, if the length of the GOP is two seconds, an I-frame is encoded every two seconds. In short, the I-frame is a complete video image, and changes relative to the I-frame are recorded by the P-frame and the B-frame. Therefore, if there is no I-frame, the P-frame and the B-frame cannot be decoded. In other words, decoding of the decoder starts from the I-frame, because decoding of the B-frame and the P-frame needs to depend on a decoding result of the I-frame.

In an application field related to video data transmission, such as a long and short video application, a network live streaming application, a cloud desktop, and other cloud applications, emphasis is placed on optimization of a display delay of a first-screen image, and a presentation delay of the first-screen image is strived to be shortened, so that a user can view a video image more quickly, and obtain good user experience. The display delay of the first-screen image, that is, time consumed for loading the first-screen image, is a visual sensory experience indicator, and is used to measure time from opening an application/media file to displaying a video image on a screen for various video services. If the time exceeds one second, it will bring the user a poor experience that the user cannot obtain a service quickly.

However, due to existence of the GOP, the decoder in the client needs to wait for a key frame for decoding. For example, when a client of a user enters a live streaming room, a picture frame obtained from the server end is not the key frame, and the decoder can wait only. In this case, a black screen occurs, and waiting time may approach a length of one GOP. For example, assuming that one GOP includes 50 frames, the 1^{st} frame is an I-frame, and a video image obtained when the client enters the live streaming room is the 5^{th} frame in the GOP, those images obtained subsequently up to the 50^{th} frame cannot be immediately decoded, and until a next I-frame is obtained, the I-frame can be decoded to display the first-screen image.

### SUMMARY

Embodiments of the present disclosure provide a video data transmission method, a device, a storage medium, and a system, to shorten a display delay of a first-screen image.

According to a first aspect, an embodiment of the present disclosure provides a video data transmission method, applied to a client. The method includes: sending, in response to establishing a communication connection with a server end, an obtaining request for obtaining a key frame to the server end, to enable the server end to encode a current to-be-transmitted video image into a first key frame; receiving the first key frame fed back by the server end, where the first key frame includes first decoding information; and decoding the first key frame based on the first decoding information, to display the decoded video image.

According to a second aspect, an embodiment of the present disclosure provides a video data transmission apparatus, applied to a client. The apparatus includes: a sending module, configured to: send, in response to establishing a communication connection with a server end, an obtaining request for obtaining a key frame to the server end, to enable the server end to encode a current to-be-transmitted video image into a first key frame; a receiving module, configured to receive the first key frame fed back by the server end, where the first key frame includes first decoding information; and a decoding module, configured to decode the first key frame based on the first decoding information, to display the decoded video image.

According to a third aspect, an embodiment of the present disclosure provides an electronic device, including: a memory, a processor, and a communication interface. The memory stores executable codes, and when the executable codes are executed by the processor, the processor is enabled to perform the video data transmission method according to the first aspect.

According to a fourth aspect, an embodiment of the present disclosure provides a non-transitory machine-readable storage medium. The non-transitory machine-readable storage medium stores executable codes, and when the executable codes are executed by a processor of an electronic device, the processor is enabled to at least implement the video data transmission method according to the first aspect.

According to a fifth aspect, an embodiment of the present disclosure provides a video data transmission method, applied to a server end. The method includes: receiving an obtaining request for obtaining a key frame, the obtaining request being sent by a client after the client establishes a communication connection with the server end; encoding a current to-be-transmitted video image into a key frame, where the key frame includes decoding information; and sending the key frame to the client, to enable the client to display, after decoding the key frame based on the decoding information, the decoded video image.

According to a sixth aspect, an embodiment of the present disclosure provides a video data transmission apparatus, applied to a server end. The apparatus includes: a receiving module, configured to receive an obtaining request for obtaining a key frame, the obtaining request being sent by a client after the client establishes a communication connection with the server end; an encoding module, configured to encode a current to-be-transmitted video image into a key frame, where the key frame includes decoding information; and a sending module, configured to send the key frame to the client, to enable the client to display, after decoding the key frame based on the decoding information, the decoded video image.

According to a seventh aspect, an embodiment of the present disclosure provides an electronic device, including: a memory, a processor, and a communication interface. The memory stores executable codes, and when the executable codes are executed by the processor, the processor is enabled to perform the video data transmission method according to the fifth aspect.

According to an eighth aspect, an embodiment of the present disclosure provides a non-transitory machine-readable storage medium. The non-transitory machine-readable storage medium stores executable codes, and when the executable codes are executed by a processor of an electronic device, the processor is enabled to at least implement the video data transmission method according to the fifth aspect.

According to a ninth aspect, an embodiment of the present disclosure provides a video data transmission method, applied to a first client. The method includes: sending, in response to a screen sharing operation triggered by a user on the first client, an obtaining request for obtaining a key frame to a first cloud desktop connected to the first client, to enable the first cloud desktop to encode a current to-be-transmitted video image into a first key frame, where the video image is an image currently presented by the first cloud desktop; receiving the first key frame fed back by the first cloud desktop, where the first key frame includes first decoding information; and sending the first key frame to a second client, to enable the second client to display, after decoding the first key frame based on the first decoding information, the decoded video image, where the second client is connected to a second cloud desktop.

According to a tenth aspect, an embodiment of the present disclosure provides a video data transmission apparatus, applied to a first client. The apparatus includes: a sending module, configured to send, in response to a screen sharing operation triggered by a user on the first client, an obtaining request for obtaining a key frame to a first cloud desktop connected to the first client, to enable the first cloud desktop to encode a current to-be-transmitted video image into a first key frame, where the video image is an image currently presented by the first cloud desktop; a receiving module, configured to receive the first key frame fed back by the first cloud desktop, where the first key frame includes first decoding information; and a decoding module, configured to send the first key frame to a second client, to enable the second client to display, after decoding the first key frame based on the first decoding information, the decoded video image, where the second client is connected to a second cloud desktop.

According to an eleventh aspect, an embodiment of the present disclosure provides an electronic device, including: a memory, a processor, and a communication interface. The memory stores executable codes, and when the executable codes are executed by the processor, the processor is enabled to perform the video data transmission method according to the ninth aspect.

According to a twelfth aspect, an embodiment of the present disclosure provides a non-transitory machine-readable storage medium. The non-transitory machine-readable storage medium stores executable codes, and when the executable codes are executed by a processor of an electronic device, the processor is enabled to at least implement the video data transmission method according to the ninth aspect.

According to a thirteenth aspect, an embodiment of the present disclosure provides a video data transmission system, including: a first cloud desktop, a second cloud desktop, a first client connected to the first cloud desktop, and a second client connected to the second cloud desktop. The first client is configured to: send, in response to a screen sharing operation triggered by a user on the first client, an obtaining request for obtaining a key frame to the first cloud desktop; receive a first key frame fed back by the first cloud desktop, where the first key frame includes first decoding information; and send the first key frame to the second client. The first cloud desktop is configured to encode, in response to the obtaining request, a current to-be-transmitted first video image into the first key frame and feed back the first key frame to the first client, where the first video image is an image currently presented by the first cloud desktop. The second client is configured to: decode the first key frame based on the first decoding information; and display a second video image and the decoded first video image, where the second video image is an image currently presented by the second cloud desktop. The second cloud desktop is configured to transmit video images corresponding to the second cloud desktop to the second client.

It should be noted that, the foregoing summary is merely for the purpose of the specification, and is not intended to be limited in any manner. In addition to the exemplary aspects, implementations, and features described above, the aspects, implementations, and features of this disclosure may be easily understood by referring to the accompanying drawings and the following detailed descriptions.

### BRIEF DESCRIPTION OF DRAWINGS

To describe the technical solutions in embodiments of the present disclosure more clearly, the following briefly describes the accompanying drawings required for describing embodiments. Apparently, the accompanying drawings in the following description show merely some embodiments of the present disclosure, and a person of ordinary skill in the art may still derive other drawings from these accompanying drawings without creative efforts.

FIG. 1 is a flowchart of a video data transmission method according to an embodiment of the present disclosure.

FIG. 2 is a flowchart of a video data transmission method according to an embodiment of the present disclosure.

FIG. 3 is a flowchart of a video data transmission method according to an embodiment of the present disclosure.

FIG. 4 is a schematic diagram of a cloud desktop-based video data transmission system according to an embodiment of the present disclosure.

FIG. 5 is a flowchart of a video data transmission method according to an embodiment of the present disclosure.

FIG. 6 is a schematic application diagram of a video data transmission method according to an embodiment of the present disclosure.

FIG. 7 is a schematic execution flowchart of a teacher client in a digital education scenario according to an embodiment of the present disclosure.

FIG. 8 is a schematic execution flowchart of a student client in a digital education scenario according to an embodiment of the present disclosure.

FIG. 9 is a schematic diagram of a structure of a video data transmission apparatus according to an embodiment of the present disclosure.

FIG. 10 is a schematic diagram of a structure of an electronic device according to an embodiment.

FIG. 11 is a schematic diagram of a structure of a video data transmission apparatus according to an embodiment of the present disclosure.

FIG. 12 is a schematic diagram of a structure of an electronic device according to an embodiment.

### DETAILED DESCRIPTION

To make the objectives, technical solutions, and advantages of the embodiments of the present disclosure clearer, the following clearly and completely describes the technical solutions in embodiments of the present disclosure with reference to the accompanying drawings in embodiments of the present disclosure. Apparently, the described embodiments are merely some embodiments of the present disclosure rather than all of the embodiments. All other embodiments obtained by a person of ordinary skill in the art based on embodiments of the present disclosure without creative efforts shall fall within the protection scope of the present disclosure. In addition, a sequence of steps in the following method embodiments is merely an example, and is not strictly limited.

It should be noted that, user information (including, but not limited to, user equipment information, user personal information, and the like) and data (including, but not limited to, data for analysis, stored data, displayed data, and the like) involved in the embodiments of the present disclosure are both information and data that are authorized by a user or that are sufficiently authorized by all parties, and related data needs to be collected, used, and processed by complying with related laws and regulations and standards of related countries and regions, and a corresponding operation entry is provided for the user to select to authorize or reject.

First, some concepts involved in the embodiments of the present disclosure are explained and described.

A group of pictures (Group Of Pictures, GOP for short) is generated by video encoding, and is a group of pictures including a key frame (I-frame). An I-frame in a GOP is the 1^{st} encoded frame in the GOP, and a length of the GOP is a distance between two I-frames, and may be represented by using a time length between two I-frame time points.

A sequence parameter set (Sequence Parameter Set, SPS for short) includes decoding-related information, for example, a profile level, resolution, an encoding tool switch identifier and a related parameter in a profile, and time-domain scalability information.

A picture parameter set (Picture Parameter Set, PPS for short) describes public parameters used by pictures, for example, initial picture control information, an initialization parameter, and partitioning information.

An instantaneous decoding refresh (Instantaneous Decoding Refresh, IDR for short)-frame includes complete decoding information needed for frame decoding, for example, an SPS and a PPS. The frame can be decoded by a decoder to restore an original picture without referring to another frame. A function of the IDR-frame is to immediately refresh, so that an error cannot be propagated. When receiving the IDR-frame, the decoder clears a reference frame list. In other words, for a frame after a specific IDR-frame, the decoder does not refer to any frame before the IDR-frame for decoding. It should be noted that, the IDR-frame is an I-frame, but the I-frame includes, but is not limited to, the IDR-frame. In other words, the I-frame is divided into a regular I-frame and a special I-frame, that is, the IDR-frame, both of which include complete decoding information, and decoding can be completed without depending on another frame. Compared with the IDR-frame, a P-frame and a B-frame after the regular I-frame may be decoded by referring to previous frames across the regular I-frame.

Multicast is a one-to-many communication mode between hosts, and allows one or more multicast sources to send a same packet to a plurality of receivers in a same multicast group. Multicast groups are distinguished based on multicast addresses.

A real-time stream protocol (Real-Time Stream Protocol, RTSP for short) is an application layer protocol based on text. Packet types of RTSP are classified into a request packet and a response packet. A URL link starting from “rtsp” or “rtspu” is used to specify that the RTSP protocol is currently used, and may be analyzed by using some media tools, to request to obtain corresponding media data from a media server. This is usually found in streaming applications such as video live streaming and multicast.

Using a real-time video live streaming application as an example, because existence of the GOP, a video decoder of a client, that is, a playback end, needs to wait for an I-frame for decoding. If a key frame is not first pulled from a server end, the decoder can wait only. In this case, a black screen occurs, and decoding can only be performed until a next I-frame is received, to display a first-screen image.

To display a real-time image when entering a live streaming room, a common optimization method at the server end is to perform GOP caching at an edge node of a content delivery network (Content Delivery Network, CDN for short). In many cases, a previous GOP is cached. The edge node is a node close to the client or even accessed by the client. A disadvantage of this method is that there is a playback delay because the client always performs, starting from a previous I-frame, decoding and playback for displaying, and display delay time is at least a length of one GOP.

To shorten the playback delay, in some application scenarios with a high real-time requirement, the server end may reduce the length of the GOP, in other words, set a GOP with a short length. However, this causes an increase in a quantity of I-frames within a same time period. For example, there is one I-frame in an original GOP with a length of two seconds, but if the length of the GOP is set to 500 milliseconds, there are four I-frames in a same time period of two seconds. Actually, compared with the P-frame and the B-frame, the I-frame adopts an intra-frame encoding mode with a low compression rate. In this way, more I-frames need to consume more network bandwidths and have a high requirement on a network bandwidth.

In view of this, in the video data transmission solution provided in embodiments of the present disclosure, when a client establishes a communication connection with a server end and the client pulls a video stream from the server end, first, the client actively sends a set signaling request, that is, an obtaining request for requesting a key frame, to the server end, so that the server end encodes a video image that needs to be transmitted after receiving the obtaining request into the key frame and feeds back the key frame to the client, and the client can complete decoding and display of the key frame in time based on complete decoding information, such as information, for example, an SPS and a PPS, included in the key frame. In this way, the client can display a first-screen image quickly. Then, the server end continues to encode subsequent video images into P-frames and B-frames, and delivers the P-frames and the B-frames to the client. The client decodes and displays, based on a decoding result of the key frame, the P-frames and the B-frames that are subsequently received.

In this way, the client actively requests the key frame from the server end on a cloud side to overcome a problem of an excessively large display delay of the first-screen image caused by incapability of obtaining sufficient decoding information in time in a process of pulling a video stream on a client side, without apparently increasing occupation of a network bandwidth, generating an end-cloud collaborative optimization solution.

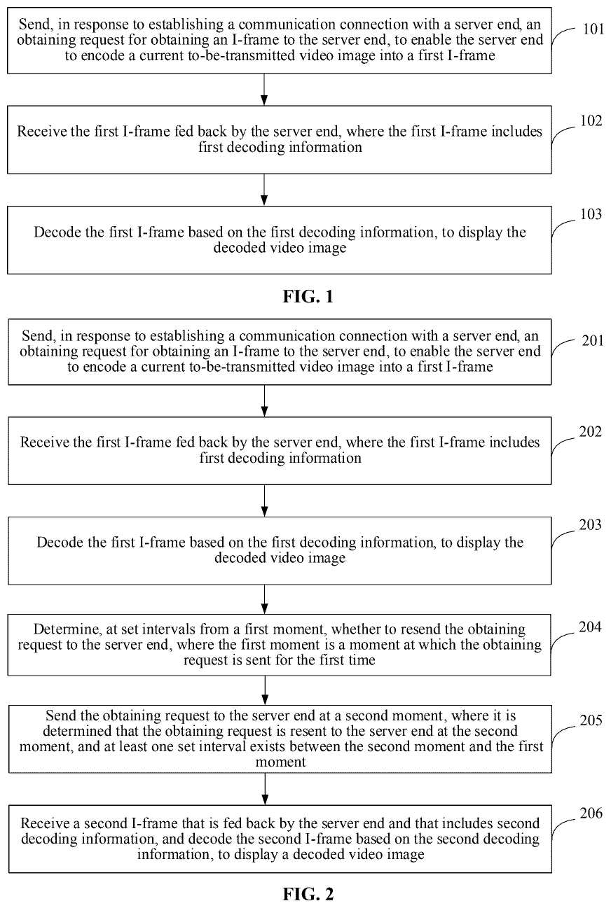

FIG. 1 is a flowchart of a video data transmission method according to an embodiment of the present disclosure. The method may be performed by a client. As shown in FIG. 1, the method includes the following steps. 101: Send, in response to establishing a communication connection with a server end, an obtaining request for obtaining an I-frame to the server end, to enable the server end to encode a current to-be-transmitted video image into a first I-frame. 102: Receive the first I-frame fed back by the server end, where the first I-frame includes first decoding information. 103: Decode the first I-frame based on the first decoding information, to display the decoded video image.

Using a live streaming application scenario as an example, the client may be a live streaming application installed in a terminal device of a user. When the user starts the client and taps to enter a live streaming room for viewing, the client establishes the communication connection with the server end. The communication connection includes, but is not limited to, a communication connection established based on an RTSP protocol. In this case, the client sends an obtaining request for obtaining an IDR-frame to the server end.

The server end may be a server or a server cluster corresponding to a live streaming application in a cloud.

In a process in which the server end transmits video stream data, it is assumed that a length of a GOP included in a used default encoding parameter is a second GOP length. For example, if the second GOP length is two seconds, the server end encodes and generates one I-frame every two seconds.

For ease of description by using an example, it is first assumed that based on the second GOP length, encoding results of the service end on 10 consecutive video images F1, F2, F3, . . . , and F10 included in the video stream data are: I, P, B, B, P, B, B, P, B, and B, and it is assumed that the 10 encoded frames form one GOP (where it is assumed that the GOP is represented as a GOP 1). Each time after generating an encoded frame, the server end may transmit the encoded frame to the connected client. In the assumed situation, it is assumed that the 1^{st} encoded frame received from the server end after the client establishes the communication connection with the server end is an encoded frame corresponding to the video image F3, namely, a B-frame. Because decoding of the B-frame needs to refer to a previous P-frame and a previous I-frame, however, the P-frame and the I-frame before the B-frame are not received by the client, the client cannot immediately decode the received B-frame. Similarly, B-frames and P-frames in the GOP 1 that are received subsequently cannot be decoded either, until an I-frame included in a next GOP is received, decoding of the I-frame can only be completed based on decoding information, for example, an SPS and a PPS, included in the I-frame, to display the decoded video image.

Described above is a phenomenon of a first-screen image delay that may exist in the client when the server end encodes and transmits, after the client establishes the communication connection with the server end, a video image based on the second GOP length configured by default.

However, in the solution provided in embodiments of the present disclosure, after establishing the communication connection with the server end, the client instantly and actively sends the foregoing obtaining request for obtaining the I-frame to the server end. Assuming that the current to-be-transmitted video image of the server end is the video image F3 in the foregoing example, based on the obtaining request, the server end encodes the video image F3 into the I-frame (that is, the first I-frame in the foregoing step), and feeds back the I-frame to the client, so that the client can complete decoding of the first I-frame based on the first decoding information, for example, the SPS or the PPS, included in the first I-frame, and display the decoded video image F3.

Actually, when receiving the obtaining request, the server end starts encoding of a new GOP. Assuming that the newly started GOP is represented as a GOP 2, for the 10 video images F1 to F10 in the foregoing example, the encoding results of the server end change to:
GOP 1: I and P.
GOP 2: I, P, B, B, P, B, B, P, B, and B. The last two encoded frames B are encoding results corresponding to two video images after the foregoing 10 video images.

It is assumed that a length of the new GOP started by the server end after the server end receives the obtaining request is consistent with the second GOP length used by default. Actually, in an example, the obtaining request sent by the client to the server end may further include a first GOP length, and the first GOP length is less than the second GOP length, so that a length of the new GOP started by the server end is the first GOP length.

For optimization of a display delay of the first-screen image, the optimization can be achieved provided that the client can obtain sufficient decoding information more quickly. Therefore, the length of the new GOP may be set to the first GOP length less than the default second GOP length. Assuming that it is determined, based on the first GOP length, that the new GOP includes five encoded frames, for the 10 video images F1 to F10 in the foregoing example, the encoding results of the server end change to: GOP 1: I and P, GOP 2: I, P, B, B, and P, and GOP 3: I, P, B, . . .

A length of the GOP 3 becomes the second GOP length used by default. In other words, after completing encoding of a new GOP based on the received obtaining request, the server end reverts to an encoding mode used by default, to be specific, using the second GOP length. In this way, for the optimization of the display delay of the first-screen image, the server end only briefly generates a new I-frame. This does not apparently increase occupation of a network bandwidth, but may shorten the display delay of the first-screen image.

In addition, in embodiments of the present disclosure, the I-frame fed back by the server end to the client in response to the foregoing obtaining request that is sent by the client and that is used for obtaining the I-frame may be a regular I-frame, or may be an IDR-frame.

In most video applications, generally, a client side sets a cache queue, and configures a corresponding cache parameter, to cache video stream data with a specific length after the communication connection is established with the server end, so as to analyze information needed for decoding. By default, this process is time-consuming, and consequently, a display delay of the first-screen image is affected. To ensure that sufficient decoding information can be parsed out from cached data, the cache parameter above is usually set to be large. In an example, the cache parameter may be measured by using an amount of the cached data, for example, a quantity of frames that are cached is set. The cache parameter may alternatively be cache duration, for example, one second. The cache duration indicates a set duration starting from the moment when receiving an encoded frame.

For the foregoing cache parameter at the client side, an optimization idea is to set the cache parameter to be small, thereby reducing time consumed by loading the first-screen image. However, if the cache parameter is set to be excessively small, actually, a cached encoded frame includes insufficient decoding information, and decoding cannot be performed, resulting in a playback failure.

Based on the solution provided in embodiments of the present disclosure, a playback success rate and the display delay of the first-screen image can be well balanced. In an example, the client actively sends the obtaining request for obtaining the I-frame to the server end after establishing the communication connection with the server end, so that the server end instantly generates a new I-frame (the foregoing first I-frame) and feeds back the new I-frame to the client. The client stores the first I-frame in the cache queue. In this way, the first I-frame including sufficient decoding information is stored in the cache queue soon after the client establishes the communication connection with the server end. In this way, the cache parameter corresponding to the cache queue may be set to be small, for example, 200 milliseconds or to cache five frames. Therefore, a decoder of the client may start decoding only after waiting for a small cache parameter value, thereby shortening the display delay of the first-screen image.

Based on this, after receiving the first I-frame fed back by the server end, the client stores the received first I-frame in a local cache queue. If a quantity of frames stored in the cache queue reaches a set quantity, or cache duration of the cache queue reaches set duration, the client reads a plurality of encoded frames already stored in the cache queue, identifies, from the plurality of encoded frames, the first I-frame included in the encoded frames, and parses out the first decoding information, for example, the SPS and the PPS, from the first I-frame, to complete decoding and display of the first I-frame based on the first decoding information.

The plurality of encoded frames are encoding results of a plurality of video image frames, and the plurality of encoded frames are encoded frames sequentially received from the server end after the communication connection is established with the server end. For example, assuming that the cache parameter is set to cache five frames, after the server end feeds back the first I-frame to the client, the P-frames and the B-frames that are obtained after encoding subsequent four video image frames are also fed back to the client in real time. And the client stores, in the cache queue, the foregoing five encoded frames that are sequentially received. When detecting that the quantity of encoded frames stored in the cache queue reaches the set quantity five, the decoder in the client starts to parse the five encoded frames already stored in the cache queue, to be specific, determines whether an I-frame is included in the five frames; parses out decoding information from the included I-frame; decodes and displays the I-frame based on the parsed decoding information; and decodes and displays the subsequent B-frames and P-frames based on a decoding result of the I-frame. It should be noted that, in the foregoing examples, starting from the 5^{th} encoded frame, subsequent encoded frames received by the client from the server end do not need to be stored in the cache queue, and may be directly sent to the decoder for decoding.

FIG. 2 is a flowchart of a video data transmission method according to an embodiment of the present disclosure. The method may be performed by a client. As shown in FIG. 2, the method includes the following steps. 201: Send, in response to establishing a communication connection with a server end, an obtaining request for obtaining an I-frame to the server end, to enable the server end to encode a current to-be-transmitted video image into a first I-frame. 202: Receive the first I-frame fed back by the server end, where the first I-frame includes first decoding information. 203: Decode the first I-frame based on the first decoding information, to display the decoded video image. 204: Determine, at set intervals from a first moment, whether to resend the obtaining request to the server end, where the first moment is a moment at which the obtaining request is sent for the first time. 205: Send the obtaining request to the server end at a second moment, where it is determined that the obtaining request is resent to the server end at the second moment, and at least one set interval exists between the second moment and the first moment. 206: Receive a second I-frame that is fed back by the server end and that includes second decoding information, and decode the second I-frame based on the second decoding information, to display a decoded video image.

After the client establishes the communication connection with the server end, and completes decoding of the first I-frame based on the first decoding information included in the first I-frame requested from the server end, to display a corresponding first-screen image, the server end continuously and sequentially delivers subsequent encoded frames to the client, and the client performs corresponding decoding and display, to present a display effect of a video stream.

In a process in which the server end transmits video data to the client, although a length of a GOP used by default is the above second GOP length, quantities of encoded frames included in different GOPs may be different. Generally, if a scene corresponding to a video image is static, a frame interval when the server end encodes the video images is large, so that one GOP includes fewer encoded frames. If the scene is dynamic, the frame interval is small, so that one GOP includes more encoded frames.

In other words, the server end may determine a size of a used frame interval based on a change degree of adjacent video images. A small change degree indicates that there is no perceptible image change in the video images within a specific time period. In this case, a large frame interval may be used to reduce a quantity of encoded frames, thereby reducing occupation of a network bandwidth. Otherwise, the change degree is large. To ensure that a user can accurately perceive a change in the video images and ensure video watching experience of the user, a small frame interval is used, so that dynamic change information of the video images is fully reserved in more encoded frames.

Based on this, it may be understood that, it is assumed that a video image change scene corresponding to a segment of a video stream currently transmitted by the server end to the client is a static scene or a low-frequency image refresh scene. In this case, a time interval at which the server end delivers an encoded frame is large, if the client does not successfully receive an I-frame in a GOP due to an abnormality such as network jitter, because the frame interval is large, and P-frames and B-frames that are received after the I-frame cannot be decoded and displayed, an apparent image stuttering at a client side is caused. However, for a dynamic change scene in which a dynamic change degree of content is high, a probability that the client cannot successfully receive the I-frame is low, and the frame interval is small. Even if a P-frame and a B-frame are missed, the user does not apparently perceive an image abnormality.

In this embodiment, in addition to sending the obtaining request for requesting the first I-frame after being connected to the server end, in a subsequent process, the client may further determine, at the set intervals, whether the obtaining request for obtaining the I-frame needs to be resent to the server end.

Assuming that a moment at which the client sends the obtaining request to the server end for the first time after establishing the communication connection with the server end is denoted as the first moment, and each of the set intervals is 200 milliseconds, determining is performed every 200 milliseconds from the first moment. Assuming that a determining result is positive at the second moment (for example, a moment of 600 milliseconds after the first moment), the obtaining request needs to be resent to the server end. Then, at the second moment, the client sends the obtaining request to the server end. The server end encodes a video image that needs to be sent to the client at the second moment into an I-frame, which is referred to as a second I-frame, and decoding information included in the I-frame is referred to as the second decoding information. The server end feeds back the second I-frame to the client, and the client parses out the second decoding information to decode the second I-frame to display the decoded video image.

In summary, an objective of determining, at the set intervals, whether the client resends the foregoing obtaining request to the server end is mainly to determine whether a current video image change scene is a dynamic scene or a static scene, where a case of low-frequency image refresh is also considered as static. Therefore, if it is determined that the scene is the static scene at the second moment, the foregoing obtaining request is sent. Otherwise, if it is determined that the scene is the dynamic scene, the foregoing obtaining request is not sent.

In an embodiment, the foregoing determining process may be implemented in the following manner: determining, at the second moment, a quantity of currently accumulated request determining times and a quantity of currently accumulated received frames; if a difference between the quantity of the received frames and the quantity of request determining times is less than or equal to a preset value, determining that the obtaining request is resent to the server end at the second moment; otherwise, if the difference is greater than the preset value, determining that the obtaining request is not resent to the server end at the second moment. The quantity of the received frames is an accumulated quantity of encoded frames received from the server end after the communication connection is established with the server end. The quantity of request determining times is a quantity of times of determining whether to send the obtaining request to the server end, and is actually a quantity of set intervals from the first moment.

In an implementation, assuming that each of the set intervals is 200 milliseconds, and the preset value that is compared with the difference is 1, after the client is connected to the server end, each time an encoded frame is received, an accumulated count is obtained, for example, represented by A. Whether the I-frame needs to be requested currently is determined every 200 milliseconds. A basis for determining is to compare a current value A with a quantity of request determining times of the I-frame. It is assumed that the quantity of request determining times is represented by B. If A−B≤1 currently, it is considered that no new encoded frame is sent within the 200 milliseconds. The client considers that a current image scene is a static scene, and requests, from the server end, to obtain the I-frame.

It may be understood that, after determining is performed each time, the counting value B is updated by adding one, regardless of whether a condition of A−B≤1 is satisfied.

It can be learned that for the client, each time it is determined that a current video image change scene is a static scene at a set interval, the client requests the server end for the I-frame, to prevent a case such as an abnormal network from affecting video watching experience of the user. In addition, assuming that after establishing the connection with the server end, the client sends the obtaining request for obtaining the I-frame to the server end, and the obtaining request is not successfully received by the server end due to a reason such as an abnormal network, it may also be ensured that the server end feeds back, by using a policy of determining once every set intervals, the I-frame to the client as soon as possible, thereby improving stability.

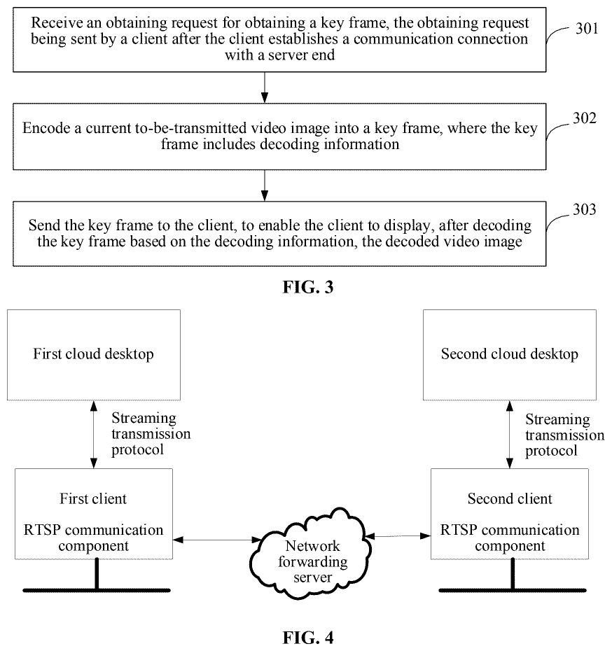

FIG. 3 is a flowchart of a video data transmission method according to an embodiment of the present disclosure. The method may be performed by a server end. As shown in FIG. 3, the method includes the following steps. 301: Receive an obtaining request for obtaining a key frame, the obtaining request being sent by a client after the client establishes a communication connection with the server end. 302: Encode a current to-be-transmitted video image into a key frame, where the key frame includes decoding information. 303: Send the key frame to the client, to enable the client to display, after decoding the key frame based on the decoding information, the decoded video image.

In this embodiment, steps are performed by the server end. For a specific implementation process, refer to related descriptions in the foregoing embodiments, and details are not described herein again.

The foregoing end (the client)-cloud (the server end) collaborative solution that can optimize a display delay of a first-screen video image provided in this embodiment of the present disclosure may be applied to many application scenarios of video data transmission, including but not limited to a live streaming scenario, for example, may further be applied to an application scenario such as a cloud desktop.

The cloud desktop may perform communication with a corresponding client by using a streaming transmission protocol. In short, the cloud desktop encodes image content displayed on the desktop into a video stream and transmits the video stream to the client for decoding and display.

The cloud desktop may be used in many specific application scenarios, such as an office scenario and a teaching scenario. The office scenario is a common usage scenario of the cloud desktop, and details are not described herein.

In the teaching scenario, for example, for tasks such as teacher teaching and student demonstration, the cloud desktop may be used. For example, a cloud desktop of a teacher shares screen content of the teacher to students in a same electronic classroom in real time, thereby implementing unified teaching of the teacher. For example, a student shares screen content on a cloud desktop of the student to a teacher and other students in real time, to facilitate sharing among classmates and mutual learning.

The foregoing specific application scenarios are all inseparable from screen display. Therefore, optimization of a display delay of a first-screen image is also very important. Waiting due to the delay not only affects pace of the teacher in classes, but also affects class efficiency. Therefore, in the foregoing examples of the application scenarios, a video data transmission solution provided in this embodiment of the present disclosure may be used to optimize the display delay of the first-screen image.

A cloud desktop-based video transmission process is specifically described below.

FIG. 4 is a schematic diagram of a cloud desktop-based video data transmission system according to an embodiment of the present disclosure. As shown in FIG. 4, the system includes: a first cloud desktop, a second cloud desktop, a first client connected to the first cloud desktop, and a second client connected to the second cloud desktop.

As described above, a communication connection between the first cloud desktop and the first client may be a communication connection supporting a streaming transmission protocol. Similarly, a communication connection between the second cloud desktop and the second client may also be a communication connection supporting the streaming transmission protocol.

In an implementation, to implement video data transmission between different clients, as shown in FIG. 4, the system may further include: a network forwarding server.

Assuming that video data transmission is performed between the first client, the second client, and the network forwarding server by using an RTSP protocol, as shown in FIG. 4, the first client and the second client further include communication components supporting the RTSP protocol, that are, RTSP communication components, which may implement conversion between video data corresponding to the streaming transmission protocol and video data corresponding to the RTSP protocol.

With reference to some actual application requirements, for example, different employees in a same company may have a cloud desktop sharing requirement, and a teacher and students in an electronic classroom may have a cloud desktop sharing requirement, in a specific implementation process, the first client and the second client may be in a same multicast group. In this case, one multicast group may include clients corresponding to many users (for example, clients corresponding to one teacher and many students), and the first client and the second client are only two of the clients. Because principles of video data transmission processes between different clients are similar, in this embodiment of the present disclosure, only the two clients are used as an example for description.

Based on the foregoing system composition, using a process in which the first client shares screen content of the first cloud desktop to the second client as an example, a video data transmission solution is as follows. The first client sends, in response to a screen sharing operation triggered by a user on the first client, an obtaining request for obtaining an I-frame to the first cloud desktop, receives a first I-frame fed back by the first cloud desktop, where the first I-frame includes first decoding information, and sends the first I-frame to the second client.

The first cloud desktop encodes, in response to the obtaining request, a current to-be-transmitted first video image into the first I-frame and feeds back the first I-frame to the first client, where the first video image is an image currently presented by the first cloud desktop.

The second client decodes the first I-frame based on the first decoding information, and displays the decoded first video image on a second video image, where the second video image is an image currently presented by the second cloud desktop.

The second cloud desktop transmits video images corresponding to the second cloud desktop to the second client.

Assuming that an operator corresponding to the first client is referred to as a user 1, and an operator corresponding to the second client is referred to as a user 2, after the user 1 and the user 2 log in to respective clients thereof, the user 1 and the user 2 establish communication connections with respective corresponding cloud desktops, and can view video images of corresponding cloud desktops on respective client interfaces. There is no display delay problem of a first-screen image in this process.

When the user 1 triggers a screen sharing operation on the first client, it means that the user 1 wants to share a screen image of the first cloud desktop to another user. It is assumed that the screen image is shared to the user 2. In response to the screen sharing operation triggered by the user 1, the first client sends the obtaining request for obtaining the I-frame to the first cloud desktop through the communication connection with the first cloud desktop. In response to the obtaining request, the first cloud desktop encodes the current to-be-transmitted first video image into the first I-frame, and feeds back the first I-frame to the first client. The first I-frame includes the first decoding information. The first video image is screen content displayed on the first cloud desktop when the obtaining request is received.

After receiving the first I-frame, the first client forwards the first I-frame to the second client, so that the second client decodes the first I-frame based on the first decoding information in the first I-frame, and displays the corresponding first video image on the second client.

It should be noted that, after the user 2 opens the second client, the second client is connected to the second cloud desktop, so that the second cloud desktop delivers a video stream corresponding to the second cloud desktop to the second client in real time, and the second client decodes and displays the video stream. Therefore, when the second client decodes the first I-frame to obtain the corresponding first video image, the second video image decoded from the video stream transmitted by the second cloud desktop is already displayed on the second client, and the second client may display the first video image on the second video image in a floating manner.

For example, at a moment T, the second client decodes the first video image, and an image presented on the second cloud desktop at this time is the second video image. The second client may generate a video playback window, and the first video image is displayed in the video playback window. A position relationship between the video playback window and a display region of the second video image is not specifically limited, and the video playback window may locate inside or outside or partially overlap the display region of the second video image.

In addition, in an implementation, an implementation in which the first client forwards the first I-frame to the second client is not specifically limited. For example, if the user 1 knows an IP address corresponding to the second client of the user 2, the user 1 may enter the IP address corresponding to the second client when triggering the screen sharing operation, to implement one-to-one forwarding. For another example, when the first client and the second client are in a same multicast group, the first I-frame may be forwarded in the following manner: The first client sends the first I-frame to the network forwarding server. The network forwarding server sends the first I-frame to a multicast address corresponding to the multicast group, and generates a corresponding target URL link. The target URL link includes the multicast address corresponding to the multicast group. Then, the network forwarding server feeds back the target URL link to the first client, and the first client sends the target URL link to the second client. After receiving the target URL link, the second client parses the target URL link, and establishes a communication connection with the network forwarding server, to obtain the first I-frame at the foregoing multicast address.

Because the first client and the second client are provided in a same multicast group, that is, a local area network, a TCP connection may be established between the first client and the second client, so that the foregoing target URL link can be forwarded. However, video data with a large amount of data is forwarded by using the network forwarding server.

According to the foregoing solution, in a cloud desktop application scenario, screen content corresponding to cloud desktops may be shared between clients corresponding to different cloud desktops. The first client used as a sharing source client requests the corresponding first cloud desktop for the I-frame when a user triggers the screen sharing operation, and forwards the I-frame to the second client used as a sharing destination client, so that the second client can display a video image of the first cloud desktop more quickly.

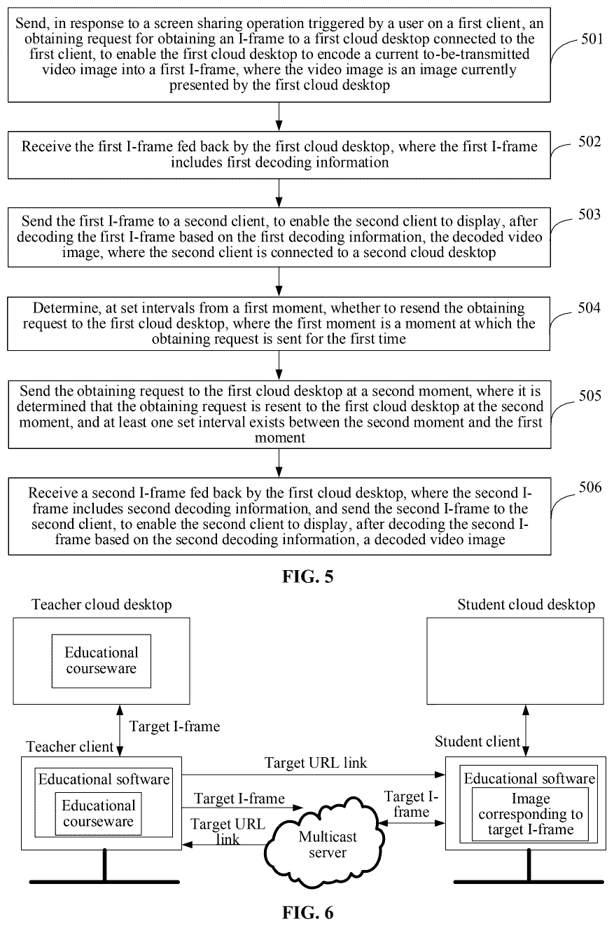

FIG. 5 is a flowchart of a video data transmission method according to an embodiment of the present disclosure. The method may be performed by a first client connected to a first cloud desktop. As shown in FIG. 5, the method includes the following steps. 501: Send, in response to a screen sharing operation triggered by a user on the first client, an obtaining request for obtaining an I-frame to the first cloud desktop connected to the first client, to enable the first cloud desktop to encode a current to-be-transmitted video image into a first I-frame, where the video image is an image currently presented by the first cloud desktop.

As described above, in an example, the obtaining request includes a first GOP length, to enable the first cloud desktop to start encoding of a new GOP after receiving the obtaining request. A length of the new GOP is the first GOP length, and the first I-frame is the 1^{st} frame in the new GOP. A length of a GOP that is used by the first cloud desktop when the first cloud desktop does not receive the obtaining request is a second GOP length, and the second GOP length is greater than the first GOP length.
502: Receive the first I-frame fed back by the first cloud desktop, where the first I-frame includes first decoding information.
503: Send the first I-frame to a second client, to enable the second client to display, after decoding the first I-frame based on the first decoding information, the decoded video image, where the second client is connected to a second cloud desktop.

As described above, the second client may store the received first I-frame in a local cache queue. If a quantity of frames stored in the cache queue reaches a set quantity, or cache duration of the cache queue reaches set duration, the second client reads a plurality of encoded frames already stored in the cache queue, and parses out the first decoding information from the first I-frame included in the plurality of encoded frames. The plurality of encoded frames are encoding results of a plurality of video image frames. The plurality of encoded frames are encoded frames that are sequentially received by the first client from the first cloud desktop and forwarded to the second client after the screen sharing operation is triggered.
504: Determine, at set intervals from a first moment, whether to resend the obtaining request to the first cloud desktop, where the first moment is a moment at which the obtaining request is sent for the first time.
505: Send the obtaining request to the first cloud desktop at a second moment, where it is determined that the obtaining request is resent to the first cloud desktop at the second moment, and at least one set interval exists between the second moment and the first moment.

For any second moment that is determined based on the foregoing set interval after the first moment, at the second moment, a quantity of currently accumulated request determining times and a quantity of currently accumulated received frames are determined, and if a difference between the quantity of the received frames and the quantity of request determining times is less than or equal to a preset value, it is determined that the obtaining request is resent to the first cloud desktop at the second moment. The quantity of the received frames is an accumulated quantity of encoded frames received from the first cloud desktop after the screen sharing operation is triggered.
506: Receive a second I-frame fed back by the first cloud desktop, where the second I-frame includes second decoding information, and send the second I-frame to the second client, to enable the second client to display, after decoding the second I-frame based on the second decoding information, a decoded video image.

For content that is not described in this embodiment, refer to related descriptions in the foregoing embodiments, and details are not described herein again.

A specific implementation process of a cloud desktop-based video data transmission solution is described below by using a digital education scenario as an example. With reference to FIG. 6, a process in which a teacher shares teaching content on a cloud desktop of the teacher to students is used as an example for description.

To implement digital education, clients of teachers and students in a class usually need to include corresponding application software. As shown in FIG. 6, educational software runs in both a teacher client and a student client. When the digital education needs to be performed, the teacher and the students in the class log in to respective clients thereof, open the educational software, and select own class from a plurality of classes displayed on the educational software to enable a digital education function. After the teacher and a plurality of students select a class, it indicates that the teacher and the plurality of students form a multicast group and are assigned a corresponding multicast group address. The student client shown in FIG. 6 is a client corresponding to any one of the plurality of students, and the teacher client and the student client are clients connected to respective cloud desktops thereof (a teacher cloud desktop and a student cloud desktop).

In a scenario in which the teacher shares teaching content to the students, screen content displayed on the teacher cloud desktop is “teaching courseware”, for example, a PPT image. After the teacher triggers a “screen sharing operation” on the educational software of the teacher, the teacher client sends an obtaining request for obtaining an I-frame to the teacher cloud desktop, and the teacher cloud desktop feeds back a target I-frame to the teacher client. The target I-frame is obtained by the teacher cloud desktop performing I-frame video encoding on the screen content displayed on the teacher cloud desktop when the obtaining request is received. The target I-frame may be a regular I-frame or an IDR-frame, and includes decoding information needed for decoding the target I-frame.

After receiving the target I-frame, the teacher client may forward the target I-frame to a multicast server shown in FIG. 6. Actually, the multicast server may be a network device such as a gateway.

In an implementation, as shown in FIG. 6, it is assumed that a communication protocol used between the teacher client and the teacher cloud desktop is ASP, a communication protocol used between the teacher client and the multicast server is RTSP, and a communication protocol used between the multicast server and the student client is RTSP. During actual application, after receiving the target I-frame, the teacher client sends the target I-frame to the multicast server, so that the multicast server performs encapsulation processing corresponding to the RTSP protocol on the target I-frame, and sends the encapsulated target I-frame to the foregoing multicast group addresses for storage.

Then, the multicast server generates a target URL link, where the target URL link includes the foregoing multicast group addresses. By accessing the target URL link, encoded frames that are received by the teacher client from the teacher cloud desktop and that include the foregoing target I-frame may be obtained. The multicast server feeds back the generated target URL link to the teacher client, and the teacher client sends the target URL link to the student client by using a communication connection (for example, a TCP connection shown in FIG. 6) between local educational software and educational software of each student.

After receiving the target URL link, the student client parses the target URL link, to determine the multicast group address included in the target URL link, so as to pull, at the multicast group address after accessing the target URL link to establish a communication connection with the multicast server, encoded frames stored in the multicast group address, where the encoded frames include the target I-frame. Further, the target I-frame is decoded and displayed based on the decoding information included in the target I-frame.

As described above, the teacher client continues to forward the encoded frames received from the teacher cloud desktop to the multicast server by using the foregoing multicast group address as a destination address, so that the student client pulls the encoded frames for decoding and display. In addition, the teacher client may further determine, at set intervals after sending the foregoing obtaining request, whether to resend the obtaining request. For a specific implementation process, refer to related descriptions in the foregoing other embodiments, and details are not described herein again.

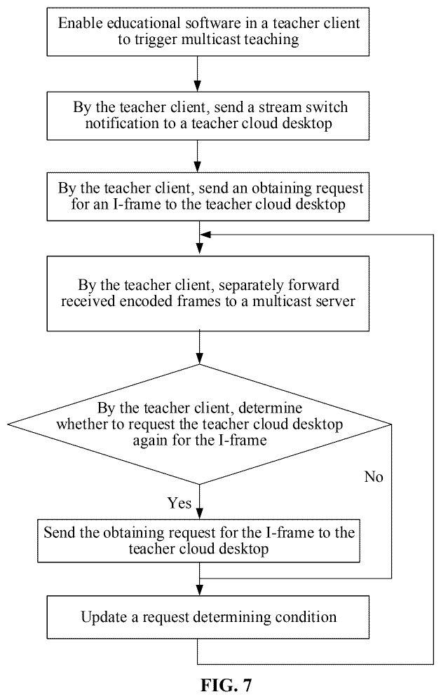

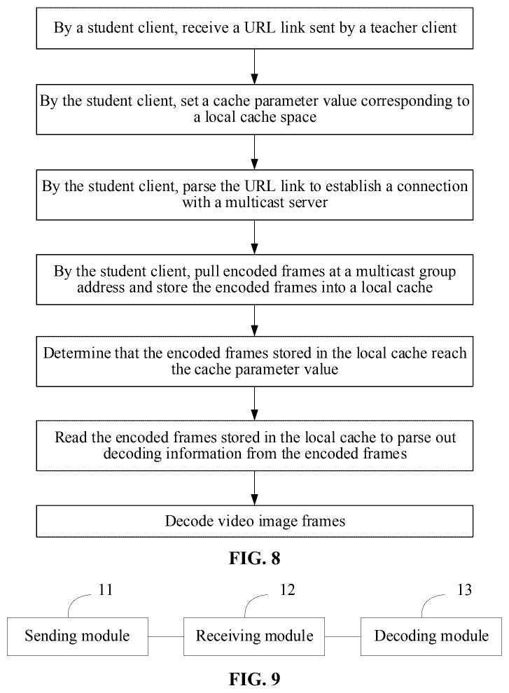

The foregoing briefly describes a video transmission process in which the teacher client shares the teaching courseware of the teacher to the student client. The following separately describes a specific implementation process of the teacher client and the student client with reference to FIG. 7 and FIG. 8.

An execution process at a teacher client side is shown in FIG. 7. In an example, first, a teacher enables educational software in a teacher client to trigger multicast teaching (that is, trigger a screen sharing function), and the teacher client sends a stream switch notification to a teacher cloud desktop based on a communication connection with the teacher cloud desktop.

In this embodiment of this disclosure, before the educational software is enabled on the teacher client, the teacher client also receives and displays a first video stream sent by the teacher cloud desktop. The first video stream is a screen image of the teacher cloud desktop before the educational software is enabled. After the educational software is enabled on the teacher client, the teacher client receives and displays a second video stream sent by the teacher cloud desktop. A video type, an encoding mode, and the like corresponding to the first video stream are different from those of the second video stream. In other words, after the educational software is enabled to start the multicast teaching, the teacher client sends the stream switch notification to the teacher cloud desktop. Then, the teacher cloud desktop performs video stream encoding on subsequent screen images on the teacher cloud desktop by using another video type and encoding mode, and sends obtained encoded frames to the teacher client.

In addition, in response to a teacher's operation of starting the multicast teaching, the teacher client may further send an obtaining request for an I-frame to the teacher cloud desktop, to receive an I-frame obtained after the teacher cloud desktop performs I-frame encoding on a current to-be-transmitted video image by using the foregoing “another video type and encoding mode”.

The teacher client separately forwards consecutively received encoded frames including the I-frame to a multicast server, so that a student client pulls the encoded frames from the multicast server. For a process in which the multicast server generates a corresponding URL link, refer to the foregoing related descriptions, and details are not described herein again.

In addition, as shown in FIG. 7, the teacher client determines, at set intervals, whether to request the teacher cloud desktop again for the I-frame. If it is needed to request the teacher cloud desktop again for the I-frame, the obtaining request for the I-frame is sent to the teacher cloud desktop, and then a request determining condition is updated. If it is not needed to request the teacher cloud desktop again for the I-frame, the request determining condition is directly updated, and then an encoded frame delivered by the teacher cloud desktop is normally received.

As described above, a basis for determining is to compare a difference between a quantity of accumulated received encoded frames and a quantity of accumulated request determining times with a set value, so that update of the request determining condition is: After determining is performed each time, the quantity of request determining times is increased by one.

An execution process at a student client side is shown in FIG. 8. In an example, the student client receives a URL link sent by a teacher client, and sets a cache parameter value corresponding to a local cache space, such as a quantity of cached frames and cache duration. The student client parses the URL link to establish a connection with a multicast server, and then pulls encoded frames at a multicast group address and stores the encoded frames in a local cache.

When the encoded frames stored in the local cache reach the cache parameter value, the encoded frames stored in the local cache are read, to parse out decoding information from the encoded frames.

Because of the request of the teacher client for the I-frame, an I-frame including needed decoding information can be quickly stored in the local cache of the student client. In this way, the cache parameter value can be set to be small. Because subsequent processing can be triggered only after the cache parameter value is reached, the small cache parameter value is set to facilitate faster decoding processing.

After obtaining, through parsing, the decoding information included in the I-frame, the student client may complete decoding and display of the I-frame, and may perform, based on a decoding result of the I-frame, subsequent decoding and display of P-frames and B-frames that depend on the I-frame.

The foregoing is described by using a scenario in which the teacher shares the teaching courseware to the students as an example. Actually, when a student has a demonstration requirement, in other words, when screen content on a student cloud desktop needs to be shared to other students and teachers, a processing process is similar, and details are not described herein again.

The following describes a video data transmission apparatus according to one or more embodiments of the present disclosure in detail. A person skilled in the art may understand that these apparatuses may be constructed by using commercial hardware components and by using steps taught in this solution.

FIG. 9 is a schematic diagram of a structure of a video data transmission apparatus according to an embodiment of the present disclosure. The apparatus is applied to a client. As shown in FIG. 9, the apparatus includes: a sending module 11, a receiving module 12, and a decoding module 13.

The sending module 11 is configured to send, in response to establishing a communication connection with a server end, an obtaining request for obtaining a key frame to the server end, to enable the server end to encode a current to-be-transmitted video image into a first key frame.

The receiving module 12 is configured to receive the first key frame fed back by the server end, where the first key frame includes first decoding information.

The decoding module 13 is configured to decode the first key frame based on the first decoding information, to display the decoded video image.

In an implementation, the obtaining request includes a first group of pictures (GOP) length, to enable the server end to start encoding of a new group of pictures, where a length of the new group of pictures is the first GOP length, and the first key frame is the 1^{st} frame in the new group of pictures; and a length of a GOP used by the server end when the server end does not receive the obtaining request is a second GOP length, where the second GOP length is greater than the first GOP length.

In an implementation, the apparatus further includes: a determining module, configured to determine, at set intervals from a first moment, whether to resend the obtaining request to the server end, where the first moment is a moment at which the obtaining request is sent for the first time. The sending module 11 is further configured to send the obtaining request to the server end at a second moment, where it is determined that the obtaining request is resent to the server end at the second moment, and at least one set interval exists between the second moment and the first moment. The receiving module 12 is further configured to receive a second key frame fed back by the server end, where the second key frame includes second decoding information. The decoding module 13 is further configured to decode the second key frame based on the second decoding information, to display a decoded video image.

In an example, the determining module is specifically configured to determine, to resend the obtaining request to the server end at the second moment, if it is determined at the second moment that a current video image change scene is a static scene.

In an example, the determining module is specifically configured to: determine a quantity of currently accumulated request determining times and a quantity of currently accumulated received frames at the second moment, where the quantity of the received frames is an accumulated quantity of encoded frames received from the server end after the communication connection is established with the server end; and determine, if a difference between the quantity of the received frames and the quantity of the request determining times is less than or equal to a preset value, to resend the obtaining request to the server end at the second moment.

In an implementation, the decoding module 13 is specifically configured to: store the received first key frame in a local cache queue; read a plurality of encoded frames stored in the cache queue if a quantity of frames stored in the cache queue reaches a set quantity, or cache duration of the cache queue reaches set duration, where the plurality of encoded frames are encoding results of a plurality of video image frames, and the plurality of encoded frames are encoded frames sequentially received from the server end after the communication connection is established with the server end; and parse out the first decoding information from the first key frame included in the plurality of encoded frames.

The apparatus shown in FIG. 9 may perform steps performed by the client in the foregoing embodiments. For detailed execution processes and technical effects, refer to descriptions in the foregoing embodiments, and details are not described herein again.

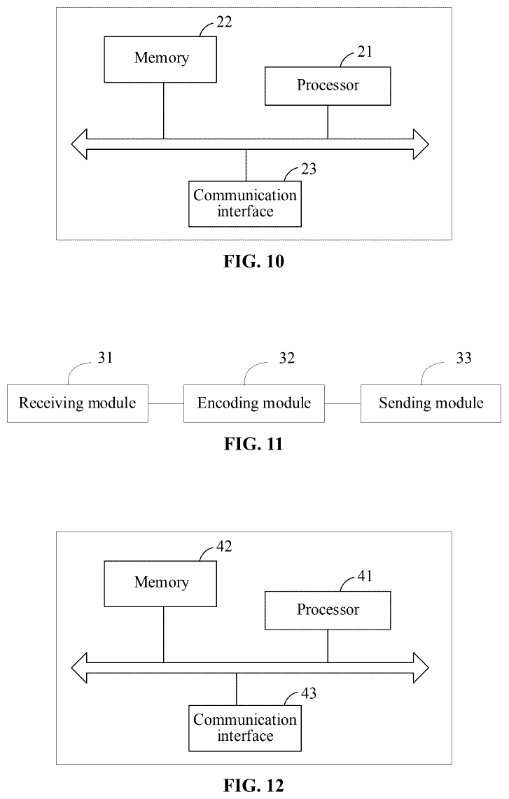

In a possible design, the structure of the video data transmission apparatus shown in FIG. 9 may be implemented as an electronic device. As shown in FIG. 10, the electronic device may include: a processor 21, a memory 22, and a communication interface 23. The memory 22 stores executable codes. When the executable codes are executed by the processor 21, the processor 21 may be enabled to at least implement the video data transmission method performed by the client in the foregoing embodiments.

FIG. 11 is a schematic diagram of a structure of a video data transmission apparatus according to an embodiment of the present disclosure. The apparatus is applied to a server end. As shown in FIG. 11, the apparatus includes: a receiving module 31, an encoding module 32, and a sending module 33.

The receiving module 31 is configured to receive an obtaining request for obtaining a key frame, the obtaining request being sent by a client after the client establishes a communication connection with the server end.

The encoding module 32 is configured to encode a current to-be-transmitted video image into a key frame, where the key frame includes decoding information.

The sending module 33 is configured to send the key frame to the client, to enabled the client to display, after decoding the key frame based on the decoding information, the decoded video image.

The apparatus shown in FIG. 11 may perform steps performed by the server end in the foregoing embodiments. For detailed execution processes and technical effects, refer to descriptions in the foregoing embodiments, and details are not described herein again.

In a possible design, the structure of the video data transmission apparatus shown in FIG. 11 may be implemented as an electronic device. As shown in FIG. 12, the electronic device may include: a processor 41, a memory 42, and a communication interface 43. The memory 42 stores executable codes. When the executable codes are executed by the processor 41, the processor 41 may be enabled to at least implement the video data transmission method performed by the server end in the foregoing embodiments.

In addition, an embodiment of the present disclosure provides a non-transitory machine-readable storage medium. The non-transitory machine-readable storage medium stores executable codes, and when the executable codes are executed by a processor of an electronic device, the processor is enabled to at least implement the video data transmission method according to the foregoing embodiments.

The described apparatus embodiments are merely examples. The units described as separate parts may or may not be physically separated. Some or all of the modules may be selected based on actual requirements to achieve the objectives of the solutions of the embodiments. A person of ordinary skill in the art may understand and implement the embodiments without creative efforts.

Through the description of the foregoing implementations, a person skilled in the art can clearly understand that each implementation can be implemented by using a necessary general hardware platform, and certainly, can alternatively be implemented by a combination of hardware and software. Based on such understanding, the essence of the foregoing technical solutions or the part contributing to a related technology can be embodied in a form of a computer product. The present disclosure may use a form of a computer program product that is implemented on one or more computer-usable storage media (including but not limited to a magnetic disk storage, a CD-ROM, an optical memory, and the like) that include computer-usable program code.

Finally, it should be noted that, the foregoing embodiments are merely used for describing the technical solutions of the present disclosure, but are not intended to limit the present disclosure. Although the present disclosure is described in detail with reference to the foregoing embodiments, it should be appreciated by a person skilled in the art that, modifications may still be made to the technical solutions described in the foregoing embodiments, or equivalent replacements may be made to the part of the technical features; and such modifications or replacements do not cause the essence of corresponding technical solutions to depart from the spirit and scope of the technical solutions in embodiments of the present disclosure.

1. A video data transmission method, applied to a client, wherein the method comprises:
sending, in response to establishing a communication connection with a server end, an obtaining request for obtaining a key frame to the server end, to enable the server end to encode a current to-be-transmitted video image into a first key frame;
receiving the first key frame fed back by the server end, wherein the first key frame comprises first decoding information; and
decoding the first key frame based on the first decoding information, to display the-a decoded video image.

2. The method according to claim 1, wherein the obtaining request comprises a first group of pictures (GOP) length, to enable the server end to start encoding of a new group of pictures, wherein a length of the new group of pictures is the first GOP length, and the first key frame is a 1^{st} frame in the new group of pictures; and
a length of a GOP used by the server end when the server end does not receive the obtaining request is a second GOP length, wherein the second GOP length is greater than the first GOP length.

3. The method according to claim 1, wherein the method further comprises:
determining, at set intervals from a first moment, whether to resend the obtaining request to the server end, wherein the first moment is a moment at which the obtaining request is sent for the first time;
sending the obtaining request to the server end at a second moment, wherein it is determined that the obtaining request needs to be resent to the server end at the second moment, and at least one set interval exists between the second moment and the first moment;
receiving a second key frame fed back by the server end, wherein the second key frame comprises second decoding information; and
decoding the second key frame based on the second decoding information, to display a decoded video image.

4. The method according to claim 3, wherein the determining, at set intervals, whether to resend the obtaining request to the server end comprises:
determining, to resend the obtaining request to the server end at the second moment, in response to a determination at the second moment that a current video image change scene is a static scene.

5. The method according to claim 4, wherein determining, at the second moment, whether the current video image change scene is the static scene comprises:
determining a quantity of currently accumulated request determining times and a quantity of currently accumulated received frames at the second moment, wherein the quantity of the received frames is an accumulated quantity of encoded frames received from the server end after the communication connection is established with the server end; and
determining that the current video image change scene is the static scene, in response to a difference between the quantity of the received frames and the quantity of the request determining times being less than or equal to a preset value.

6. The method according to claim 1, wherein the decoding the first key frame based on the first decoding information, to display the decoded video image comprises:
storing the received first key frame in a local cache queue;
reading a plurality of encoded frames stored in the cache queue, in response to a quantity of frames stored in the cache queue reaching a set quantity, or cache duration of the cache queue reaching set duration, wherein the plurality of encoded frames are encoding results of a plurality of video image frames, and the plurality of encoded frames are encoded frames sequentially received from the server end after the communication connection is established with the server end; and
parsing out the first decoding information from the first key frame comprised in the plurality of encoded frames.

7. (canceled)

8. A video data transmission method, applied to a first client, wherein the method comprises:
sending, in response to a screen sharing operation triggered by a user on the first client, an obtaining request for obtaining a key frame to a first cloud desktop connected to the first client, to enable the first cloud desktop to encode a current to-be-transmitted video image into a first key frame, wherein the video image is an image currently presented by the first cloud desktop;
receiving the first key frame fed back by the first cloud desktop, wherein the first key frame comprises first decoding information; and
sending the first key frame to a second client, to enable the second client to display, after decoding the first key frame based on the first decoding information, decoded video image, wherein the second client is connected to a second cloud desktop.

9. The method according to claim 8, wherein the method further comprises:
determining, at set intervals from a first moment, whether to resend the obtaining request to the first cloud desktop, wherein the first moment is a moment at which the obtaining request is sent for the first time;
sending the obtaining request to the first cloud desktop at a second moment, wherein it is determined that the obtaining request is resent to the first cloud desktop at the second moment, and at least one set interval exists between the second moment and the first moment;
receiving a second key frame fed back by the first cloud desktop, wherein the second key frame comprises second decoding information; and
sending the second key frame to the second client, to enable the second client to display, after decoding the second key frame based on the second decoding information, a decoded video image.

10. A video data transmission system, comprising:
a first cloud desktop, a second cloud desktop, a first client connected to the first cloud desktop, and a second client connected to the second cloud desktop, wherein
the first client is configured to: send, in response to a screen sharing operation triggered by a user on the first client, an obtaining request for obtaining a key frame to the first cloud desktop; receive a first key frame fed back by the first cloud desktop, wherein the first key frame comprises first decoding information; and send the first key frame to the second client;
the first cloud desktop is configured to encode, in response to the obtaining request, a current to-be-transmitted first video image into the first key frame and feed back the first key frame to the first client, wherein the first video image is an image currently presented by the first cloud desktop;
the second client is configured to: decode the first key frame based on the first decoding information; and display a second video image and the-a decoded first video image, wherein the second video image is an image currently presented by the second cloud desktop; and
the second cloud desktop is configured to transmit video images corresponding to the second cloud desktop to the second client.

11. The system according to claim 10, wherein the first client and the second client are in a same multicast group; the system further comprises a network forwarding server; and
the first client is specifically configured to: send the first key frame to the network forwarding server; receive a target Uniform Resource Locator (URL) link fed back by the network forwarding server; and send the target URL link to the second client;
the network forwarding server is configured to: receive the first key frame; send the first key frame to a multicast address corresponding to the multicast group; and generate the target URL link, wherein the target URL link comprises the multicast address corresponding to the multicast group; and
the second client is configured to establish a communication connection with the network forwarding server based on the target URL link, to obtain the first key frame at the multicast address.

12. The system according to claim 10, wherein
the first client is further configured to: determine, at set intervals from a first moment, whether to resend the obtaining request to the first cloud desktop, wherein the first moment is a moment at which the obtaining request is sent for the first time; send the obtaining request to the first cloud desktop at a second moment, wherein at least one set interval exists between the second moment and the first moment; and receive a second key frame fed back by the first cloud desktop, and send the second key frame to the second client, wherein the second key frame comprises second decoding information; and
the second client is further configured to decode the second key frame based on the second decoding information, and display a decoded video image.

13. An electronic device, comprising: a memory, a processor, and a communication interface, wherein the memory stores executable codes, and when the executable codes are executed by the processor, the processor is enabled to perform operations of the video data transmission method according to claim 1.

14. A non-transitory machine-readable storage medium, wherein the non-transitory machine-readable storage medium stores executable codes, and when the executable codes are executed by a processor of an electronic device, the processor is enabled to perform operations of the video data transmission method according to claim 1.

15. The electronic device according to claim 13, wherein the obtaining request comprises a first group of pictures (GOP) length, to enable the server end to start encoding of a new group of pictures, wherein a length of the new group of pictures is the first GOP length, and the first key frame is a 1^{st} frame in the new group of pictures; and
a length of a GOP used by the server end when the server end does not receive the obtaining request is a second GOP length, wherein the second GOP length is greater than the first GOP length.

16. The electronic device according to claim 13, wherein the operations further comprises:
determining, at set intervals from a first moment, whether to resend the obtaining request to the server end, wherein the first moment is a moment at which the obtaining request is sent for the first time;
sending the obtaining request to the server end at a second moment, wherein it is determined that the obtaining request needs to be resent to the server end at the second moment, and at least one set interval exists between the second moment and the first moment;
receiving a second key frame fed back by the server end, wherein the second key frame comprises second decoding information; and
decoding the second key frame based on the second decoding information, to display a decoded video image.

17. The electronic device according to claim 16, wherein the determining, at set intervals, whether to resend the obtaining request to the server end comprises:
determining, to resend the obtaining request to the server end at the second moment, in response to a determination at the second moment that a current video image change scene is a static scene.

18. The electronic device according to claim 17, wherein determining, at the second moment, whether the current video image change scene is the static scene comprises:
determining a quantity of currently accumulated request determining times and a quantity of currently accumulated received frames at the second moment, wherein the quantity of the received frames is an accumulated quantity of encoded frames received from the server end after the communication connection is established with the server end; and
determining that the current video image change scene is the static scene, in response to a difference between the quantity of the received frames and the quantity of the request determining times being less than or equal to a preset value.

19. An electronic device, comprising: a memory, a processor, and a communication interface, wherein the memory stores executable codes, and when the executable codes are executed by the processor, the processor is enabled to perform operations of the video data transmission method according to claim 8.

20. The electronic device according to claim 19, the operations further comprises:
determining, at set intervals from a first moment, whether to resend the obtaining request to the first cloud desktop, wherein the first moment is a moment at which the obtaining request is sent for the first time;
sending the obtaining request to the first cloud desktop at a second moment, wherein it is determined that the obtaining request is resent to the first cloud desktop at the second moment, and at least one set interval exists between the second moment and the first moment;
receiving a second key frame fed back by the first cloud desktop, wherein the second key frame comprises second decoding information; and
sending the second key frame to the second client, to enable the second client to display, after decoding the second key frame based on the second decoding information, a decoded video image.

21. A non-transitory machine-readable storage medium, wherein the non-transitory machine-readable storage medium stores executable codes, and when the executable codes are executed by a processor of an electronic device, the processor is enabled to perform operations of the video data transmission method according to claim 8.
